(19) United States
(12) Patent Application Publication
(10) Pub. No.: US 2011/0239904 A1
(43) Pub. Date: Oct. 6, 2011

(54) MANUFACTURED AGGREGATE MATERIAL AND METHOD

(75) Inventor: Terry L. Mitchell, Grand Rapids, MI (US)

(73) Assignee: ENVIROPRODUCTS INTERNATIONAL LLC, Longmont, CO (US)

(21) Appl. No.: 13/133,777

(22) PCT Filed: Dec. 9, 2008
(86) PCT No.: PCT/US08/86035

§ 371 Date: Jun. 9, 2011

(51) Int. Cl. C04B 28/00; C04B 18/04; C04B 18/18; C04B 18/24; C04B 18/26; C04B 18/16; C04B 18/20; B01J 19/00

(52) U.S. Cl. 106/638; 106/819; 106/823; 422/187; 422/119; 422/105

(57) ABSTRACT

The present invention provides a manufactured aggregate material that converts waste materials and/or recyclable materials (136) into construction material (154). By mixing waste materials (156) with a metal oxide and an acid, any harmful contaminates in the waste materials (136) are encapsulated and rendered into hard pellets (154) that are suitable for use in conglomerates or composites such as concrete. The manufactured aggregate material (154) may be adjusted for moisture content, density, heat capacity, and other parameters.

### FIELD OF THE INVENTION

The present invention relates generally to constituent materials for concrete, and, more particularly, to aggregate materials.

### BACKGROUND OF THE INVENTION

Concrete is typically made up of aggregate or filler materials, such as sand, gravel, or the like, and a binder or binding agent, such as portland cement. The aggregate and the binder are mixed together in a desirable proportion, and water is added to initiate a chemical reaction in the binder that hardens the mixture into finished concrete. Aggregates have additional applications, such as in place of sand and/or gravel, as a growing media for plants, water filtration, artificial stones (e.g. for landscaping), substrate materials for bio-roofs, and refractory products, for example.

Dr. Arun S. Wagh discloses in his book, “Chemically Bonded Phosphate Ceramics; Twenty-First Century Materials with Diverse Applications” (Elsevier 2004) chemicals and chemical reactions used in producing chemically-bonded phosphate ceramics, including the use of bottom ash, fly ash, and other waste materials in the production of ceramics.

Applicant is also aware of the disclosure in commonly-assigned U.S. Provisional Application Ser. No. 61/012,977, filed Dec. 12, 2007 by Jonathan E. Hampton, from which U.S. patent application, Ser. No. ______ filed Dec. ______, 2008 (attorney docket ENV03 P-100B) claims priority, which is hereby incorporated herein by reference in its entirety, and which discloses a method for producing manufactured aggregate utilizing the steps of mixing a waste material with an acid to obtain a first product, mixing the first product with a metal oxide to obtain a second product, and pelletizing the second product.

### SUMMARY OF THE INVENTION

The present invention provides a manufactured aggregate material that is made up of waste materials and/or recyclable materials. Embodiments of the present invention permit the production of finished conglomerates or composites such as concrete. The manufactured aggregate material may be approximately one-half the density of conventional aggregate materials. Additionally, embodiments of the present invention provide a method of converting waste materials, some of which may be environmentally hazardous or undesirable, into saleable and environmentally safe building materials.

According to one aspect of the invention, a method is provided for preparing aggregate material by providing a waste material, mixing the waste material with a metal oxide such as magnesium oxide to produce a first resultant product, and further mixing with an acid such as phosphoric acid to produce a second resultant product. The second product may be further processed, such as in an agglomerator, to produce aggregate material.

Optionally, the ratio of metal oxide to waste material may be between approximately 1:10 and approximately 1:14, and preferably approximately 1:12, while the ratio of acid to the waste material may be between approximately 1:7 and approximately 1:9, and preferably approximately 1:8. The recycled or waste material may be made of bottom ash, non-saleable fly ash, paper, glass, rice hulls, crushed concrete, polymers, petrochemicals, sawdust, wood chips, incinerator ash from municipal solid waste (MSW), medium density fiberboard (MDF) dust, kiln dust, soil, or other materials having similar properties, or combinations thereof. Optionally, the first product may be permitted to rest for a period of at least about three hours prior to the addition of phosphoric acid to produce the second product.

Optionally, calcium oxide may be added to the waste material at a ratio between approximately 1:50 and approximately 1:2000, and preferably approximately 1:99. Water may also be added to adjust the moisture content of the mixtures, such as to facilitate handling of the mixtures and/or to control the chemical reactions taking place in the mixtures. Optionally, boric acid may be added to the first resultant product in order to slow the reaction in the second resultant product.

According to another aspect of the invention, a method is provided for preparing aggregate material for use in concrete, where the method includes providing at least one hopper for containing a waste material, dispensing the waste material into a first mixer, dispensing metal oxide into the first mixer, and mixing the waste material and metal oxide in the first mixer to obtain a first resultant product. Optionally, water and/or calcium oxide and/or boric acid may be added to the first product to adjust its properties. Next, the first product is dispensed into a second mixer, after which phosphoric acid is dispensed into the second mixer, whereupon the first product and the phosphoric acid are mixed in the second mixer to obtain a second resultant product. Finally, the second product is dispensed into an agglomerator where it is pelletized, resulting in a pelletized manufactured aggregate material.

According to yet another aspect, a manufacturing facility is provided for manufacturing aggregate material. The facility includes a waste materials hopper, a metal oxide hopper, a water tank, first and second mixers, an acid tank, and an agglomerator. The waste materials hopper is used for storing and dispensing a waste material into the first mixer, the metal oxide hopper stores and dispenses metal oxide into the first mixer, the water tank stores and dispenses water into the first mixer, and the acid tank stores and dispenses acid into the second mixer. The first mixer receives and mixes the waste material, metal oxide, and water to produce a first resultant product, which at least partially results from a first chemical reaction in the first mixer. The second mixer receives and mixes the first mixture with the acid to produce a second resultant product upon reaction of the acid and the metal oxide. The agglomerator pelletizes the second resultant product into aggregate pellets.

Therefore, the method and facility of the present invention provides a way to convert harmful or otherwise-valueless waste materials into useful manufactured aggregate materials for substantially any application in which conventional or natural aggregates (e.g. sand and gravel) are used. The manufactured aggregate may be mixed with a binder and water and formed in any conventional manner, such as by pouring, casting, molding, extruding, or similar processes.

These and other objects, advantages, purposes, and features of the present invention will become apparent upon review of the specification in conjunction with the drawings.

### BRIEF DESCRIPTION OF THE DRAWINGS

FIG. 1 is a top plan view of a manufactured aggregate material facility in accordance with the present invention; and

FIG. 2 is a flow chart illustrating a reaction process in accordance with the present invention.

### DESCRIPTION OF THE PREFERRED EMBODIMENTS

Referring now specifically to the drawings and the illustrative embodiments depicted therein, an aggregate material manufacturing facility 110 includes a plurality of hoppers 112a, 112b, 112c for storing recycled or waste materials, a hopper 114 for storing dry metal oxide, a water storage tank 118, a hopper 120 for storing calcium oxide, an acid storage tank 122, a moisture sensor 124, a first product mixer 126, a second product mixer 128, a water mister 130, an agglomerator 132, and a screen device 134.

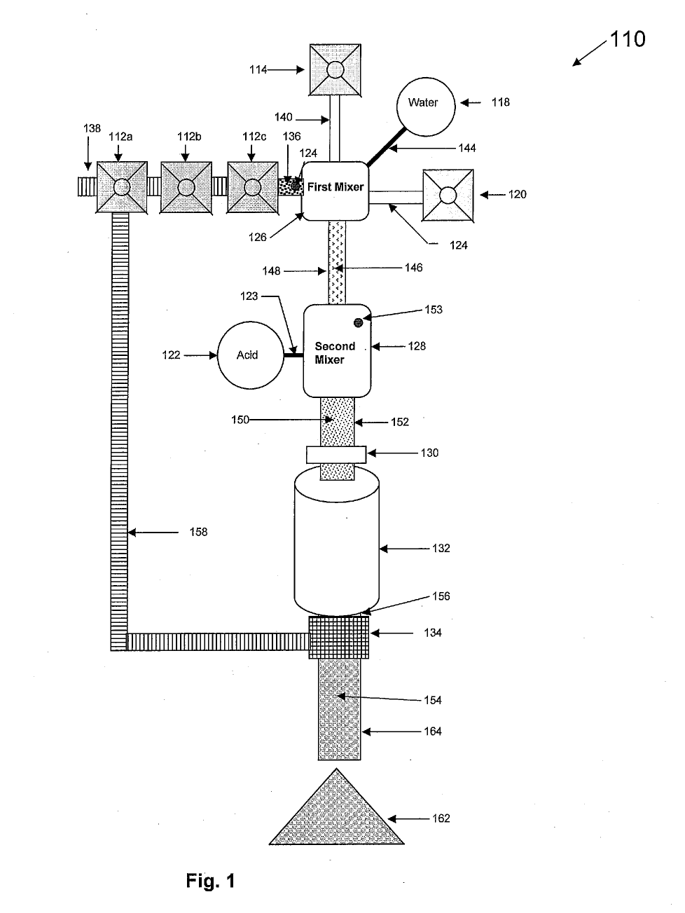

Hoppers 112a, 112b, 112c contain recycled or waste materials 136 for processing at aggregate material manufacturing facility 110 (FIG. 1). Hopper 112a may contain a wholly different material than hopper 112b, which may contain a wholly different material from hopper 112c, for example. Alternatively, hoppers 112a, 112b, 112c may contain identical materials, or different batches of similar materials, such as bottom ash produced from burning different grades of coal. If dry bottom ash or dry unsaleable fly ash (or other dry waste or recycled material) is to be used, water may be added to achieve about 5% to 10% moisture by weight to improve handling of the ash before it is added to first hopper 126. If waste materials or recycled materials are used that are not naturally in granular or small-particle form, a granulating or shredding or grinding step may be performed on the material to reduce its particle size. Optionally, hoppers 112a, 112b, 112c may store and dispense spilled, damaged, and/or rejected aggregate that may be collected from other areas of the manufacturing facility 110.

A conveyor and weigh belt 138 transports waste materials 136 from hoppers 112a, 112b, 112c to the first mixer 126. Weigh belt 138 measures the weight of waste materials 136 as they are dispensed from hoppers 112a, 112b, 112c. Hopper 114 contains and dispenses a dry metal oxide into first mixer 126 via a vacuum tube or conveyor 140. Hopper 120, which is optional, contains and dispenses calcium oxide into first mixer 126 via a vacuum tube or conveyor 142. Water tank 118 contains and dispenses water via a tube 144 to the first mixer 126. Moisture sensor 124 measures the moisture content of the waste materials that are transported on conveyor 138 to the first mixer 126.

First mixer 126 mixes waste materials 136 with a metered amount of metal oxide from hopper 114 at a ratio of between approximately 10:1 and approximately 14:1 (waste to metal oxide, by weight), and preferably approximately 12:1. Optionally, calcium oxide is added from hopper 120 to first mixer 126 at a ratio of between approximately 1:50 and approximately 1:2000, and preferably approximately 1:99 (calcium oxide to waste material, by weight). Water from tank 118 is added to first mixer 126 to mix and create a first mixture or product 146, which may have a consistency resembling damp sand. A computer or processor (not shown) receives weight data from weigh belt 138 and moisture data from sensor 124, to determine the appropriate amount of water and metal oxide to add to the waste materials in first mixer 126.

Water may be added to waste materials in first mixer 126 to account for lower moisture levels in waste materials 136, as detected by moisture sensor 124 and weigh belt 138, to achieve about 14.5% to about 23% moisture content by weight, depending on the physical properties of the waste material 136, ensuring that substantially all particles leaving first mixer 126 are wetted. The amount of metal oxide, calcium oxide, and water moisture may be varied depending on the amount and type of waste material 136, and is controlled by a predetermined mix formula programmed into the computer. For example, one such mix formula that may yield suitable results includes one ton (2,000 pounds) of bottom ash, plus 166 pounds of magnesium oxide, plus 20 pounds of calcium oxide, plus 400 pounds of water (total moisture content, including moisture that was present in waste materials 136 as they were added to first mixer 126). Waste materials 136 may be heated in first mixer 126, or heated before reaching first mixer 126, in order to facilitate a faster chemical reaction in first mixer 126, such as by using heat produced in second mixer 128 as will be described in greater detail below.

First mixer 126 can be any type of mixer capable of maintaining constant material mix ratios throughout first product 146. First mixer 126 is preferably a high-shear mixer. Suitable mixers include, for example, volumetric mixers, barrel mixers, turbine mixers, double-helix mixers, and the like, including any suitable high-shear mixing device or apparatus, such as are available from Mixer Systems, Inc. of Pewaukee, Wis., from Cementech, Inc. of Indianola, Iowa, and/or from Inventure Systems Ltd. of Ontario, Canada.

For example, first mixer 126 may be a large barrel mixer used to mix individual batches of first product 146 from measured materials, which is then dispensed onto a conveyor 148. Alternatively, a double-helix or similar mixer that mixes and provides a constant flow of premeasured materials may be computer-controlled in such a way that first product 146 consistently meets the mix formula specifications and the mixer 126 produces a constant flow of first product 146 onto conveyor 148. It will be appreciated that first product 146 is substantially non-caustic, so that it may be permitted to rest in first mixer 126 or on conveyor 148, as described below, substantially without adverse effects.

Conveyor 148 transports first product 146 to second mixer 128, where acid is dispensed from tank 122 via a tube or pipe 123 at between approximately a 1:7 acid to waste material ratio and approximately a 1:9 acid to waste material ratio, and preferably approximately a 1:8 acid to waste material ratio, by weight. The acid content ratio may be varied depending on the waste material physical properties. For example, waste material can vary by as much as 25% in weight so that a lighter waste material has a greater volume per weight, which could require more acid to ensure thorough wetting and a complete mixture. Second mixer 128, which may be a double helix screw mixer or the like, mixes the acid with first product 146 to create a thoroughly and consistently mixed second mixture or product 150, which may have a gel-like consistency similar to wet concrete. When the acid is mixed with first product 146, a chemical reaction occurs that emits heat and gases (such as gaseous sulfuric acid and other undesired chemicals), as will be described in greater detail.

While (or after) second product 150 is substantially created by mixing and reacting, second mixer 128 dispenses it onto a conveyor 152. Second mixer 128 and conveyor 152 may be shrouded and vented to contain and safely vent any toxic fumes produced in the formation of second product 150. A temperature sensor 153 may be provided at second mixer 128 to provide a temperature signal to the aforementioned processor, the temperature signal being indicative of the progress of the chemical reaction taking place as second product 150 is formed.

As second product 150 travels on conveyor 152, the chemical reaction begun in second mixer 128 continues by transforming or “setting up” second product 150 from a semi-liquid gel to a semi-hard material. The speed of conveyor 152 is set at a rate that delivers second product 150 to agglomerator 132 at a state of semi-hardness suitable for fabricating aggregate in the agglomerator. For example, a typical cure time may be approximately one minute such that the speed of conveyor 152 may be adjusted to provide about one minute of cure time on conveyor 152 between second mixer 128 and agglomerator 132. The rate of speed of conveyor 152 and therefore the cure time allowed for second product 150 is dependent on the type of waste material 136 and may be optimized by creating experimental batches. Optionally, mister 130 applies a fine mist of water to second product 150 so that second product 150 is wetted to an appropriate degree, where minimal moisture allows the second product 150 to easily break into small pellets and a wetter second product 150 tends to bind together into larger pellets inside agglomerator 132.

Conveyor 152 dispenses second product 150 into agglomerator 132. Agglomerator 132 converts second product 150 into pelletized aggregate granules or pellets 154 by agitation and/or collision, and preferably without compression. Agglomerators of this type are available, for example, from FEECO International, Inc. of Green Bay, Wis., and Mars Mineral Corp. of Mars, Pa. Agglomerator 132 may be positioned at an incline to control the approximate size of pellets 154 as they exit agglomerator 132. Agglomerator 132 produces smaller pellets when it is positioned at a relatively steep incline, such as about 10° to 20° from horizontal, and produces larger pellets when positioned at a relatively shallow incline, such as about 0° to 10° from horizontal. Other factors that may affect the size of pellets 154 include, for example, the type of agglomerator used, the moisture content of second product 150, and the speed of the agglomerator.

In one embodiment, the agglomerator may include a rotating horizontal tube, approximately 24 inches in diameter, positioned on an approximate 15° incline from horizontal. As second product 150 passes through the rotating horizontal tube, the second product 150 breaks apart into small pieces and rolls into semi-spherical shapes. The size of the semi-spherical aggregate pieces (pellets 154) is determined by the physical properties of second product 150, and the rotational speed and incline angle of horizontal tube or agglomerator 132, such as described above. As the granules or pellets 154 exit the agglomerator 138, they may have a tendency to adhere to each other if their surfaces are excessively wet. Thus, depending on the type of waste material 136 and the ambient factory temperature, it may be beneficial to move warm air, such as via a fan (not shown), through the agglomerator 132 to dry the aggregate and/or to reduce the aggregate set time by the addition of heat.

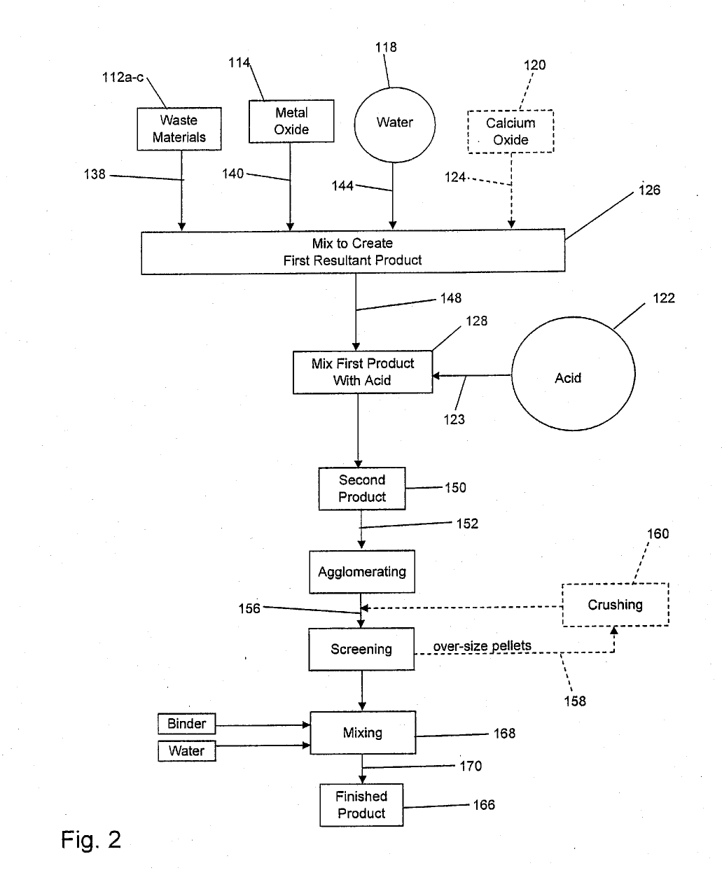

A conveyor 156 transports pellets 140 from agglomerator 132 to a screen device 134, which may include more than one screen or sieve to sort for a variety of aggregate sizes. Screen device 134 also filters out or sieves over-sized or undesirable particles for recycling and deposits them on a conveyor 158 for re-use or re-processing such as by crushing 160 (FIG. 2), whereas correctly-sized pellets pass through screen 134 and are directed to storage piles 162 via a conveyor 164, and/or are hauled away. Optionally, a plurality of screen devices having progressively larger openings or pores may be arranged in series to sort pellets 154 according to size.

Waste materials 136 typically include impurities or contaminates such as heavy metals (e.g. arsenic, selenium, cadmium), sulfur and the like, and may contain any range of moisture, from nearly zero moisture up to about 30% moisture content. Suitable materials for waste material 136 include, for example, paper, polymers, petrochemicals, rice hulls, crushed concrete, bottom ash and non-saleable fly ash left over from the burning of coal, and other waste materials including sawdust, wood chips, ash from the incineration of municipal solid waste (MSW), medium density fiberboard (MDF) dust, kiln dust, or soil. If waste materials 136 contain more than about 30% moisture by weight, it may be desirable to perform a drying process to lower the moisture to 30% or less. Alternatively, if waste materials 136 contain little or no moisture, it may be desirable to add water to raise the moisture level to at least about 10% to 15% by weight to improve its handling properties.

Waste materials 136 from hoppers 112a, 112b, 112c are mixed with a metal oxide (such as magnesium oxide (MgO)) from hopper 114 in first mixer 126 at a ratio of between approximately 10:1 and approximately 14:1, and preferably approximately 12:1. Water is added from tank 118 to achieve a moisture level ranging from 14.5% to 30% depending on the waste material's physical properties. For example, waste material including large granules will generally require less water for full wetting than waste material with finer granules because finer granules have a greater surface area. The magnesium oxide reacts with the water in first mixer 126 to release hydrogen ions into the mixture. First product 146, which is substantially chemically stable, may be permitted to rest for about three or more hours prior to adding the acid solution, which may result in the finished granules 154 being substantially harder than if less than about three hours elapses between the formation of first product 146 and the addition of acid solution.

Optionally, calcium oxide (CaO) from hopper 120 may be mixed with the waste materials, metal oxide, and water or moisture at a ratio of between approximately 1:50 and 1:2000, and preferably about 1:99 (calcium oxide to waste materials, by weight). The optional use of calcium oxide causes a reaction or bonding with residual phosphates in the waste materials, the residual phosphates existing either before the addition of phosphoric acid (such as may be present in ash with a high phosphate content) or after the addition of phosphoric acid, which can lead to the formation of residual phosphates. The addition of calcium oxide may thus be used, for example, to prevent residual phosphates from later leaching out of the aggregate, which may be particularly important in water filtration or growing media applications, for example. Mixing all of the ingredients in first mixer 126 ensures wetting and coating of the waste material 136 and impurities in the waste material with water and metal oxide (and optionally, calcium oxide) to produce the first product or mixture 146.

Optionally, boric acid (H₃BO₃) or other weak acid may be mixed with the waste materials, metal oxide, and water or moisture in first mixer 126 (or in second mixer 128, preferably before the acid from tank 122 is added), at a ratio of approximately 1:100 (boric acid to waste material, by weight). The optional use of boric acid (or other weak acid) slows the reaction of the metal oxide (such as magnesium oxide) with the acid (such as phosphoric acid) in second mixer 128, thereby slowing the crystallization process of second product 150. Slowing the reaction of second product may be advantageous when certain waste materials, containing chemicals or matter that would naturally hasten the reaction of second product, are used. Thus, the addition of boric acid or other weak acid prior to the addition of acid from tank 122 can be used to slow the reaction of second product 150 so that it does not harden to an excessive degree such that it is difficult to pelletize in agglomerator 132.

An acid, such as phosphoric acid solution (H₃PO₄) at about 75% concentration (or similar recycled phosphoric acid), is injected into second mixer 128 at a minimum ratio of approximately seven parts waste materials 136 (a component of first product 146) to one part phosphoric acid (7:1) to approximately nine parts waste materials 136 to one part phosphoric acid (9:1), and preferably approximately eight parts waste materials 136 to one part phosphoric acid (8:1) by weight, which initiates an aggressive chemical reaction between the acid and metal oxide. Other suitable acids may also be used, such as oxalic acid (H₂C₂0₄) or other acids having a pH of between about zero and about four. The temperature of the second product 150 in second mixer 128 is monitored by temperature sensor 153 to determine when the reaction is complete or nearly complete. When the temperature, which may rise about 10° to 20° Fahrenheit, begins to level off, the reaction is substantially complete and second product 150 is moved toward agglomerator 132 via conveyor 152 as the second product continues to cure.

The presence of moisture (water) in first product 146 is helpful to initiate a reaction between the waste material 136, metal oxide, and (optional) calcium oxide, and the phosphoric acid in second mixer 128. The primary reactants of second product 150, such as phosphoric acid and magnesium oxide, for example, form magnesium oxyphosphate as a binder in combination with the un-reacted portions of waste materials 136, giving second product 150 its gel-like properties. This exothermic reaction creates heat that may be withdrawn by a heat exchanger and transferred to another stage of the process, such as at first mixer 126, to increase the speed of the reaction therein. In addition to the above reactants and product, any sulfur present in waste materials 136 (such as may be present in bottom or fly ash resulting from the burning of coal) is liberated from the waste materials present in first product 146 as it is transformed into second product 150 and reacts with hydrogen and oxygen to form sulfuric gas (H₂SO₄), which may be trapped by shrouds and vented from second mixer 128 by fans. Additionally, the sulfuric gas may be passed through a heat exchanger to store heat from the gas for other uses.

After second product 150 is pelletized in agglomerator 132 and sorted at screening apparatus 134, manufactured aggregate pellets 154 typically harden further over a period of two to three days and lose moisture content as a continuation of the reaction begun in second mixer 128. Optionally, the aggregate pellets 154 may be soaked, coated, saturated, or sprayed with sodium silicate, potassium silicate, or the like to form aggregate having less than about 5% moisture content by weight.

Optionally, the final density of the aggregate pellets 154 may be adjusted by the addition of a carbonate group, such as calcium carbonate, potassium carbonate, sodium carbonate, or the like, at the high-shear mixing stage of manufacturing, and may be introduced through a port in second mixer 128, to form pockets of carbon dioxide within pellets 154. With the addition of a carbonate group, the carbonate reacts with the phosphoric acid (or other acid) to create carbon dioxide bubbles. The density of pellets 154, and thus the finished products 166 (FIG. 2) made from pellets 154, also varies by the type of ash or other waste material that is used, and the finished products may incorporate about 90% waste materials by weight. Thus, by selecting and/or blending the type of materials fed into first mixer 126 and second mixer 128, an operator may control the density and other properties of pellets 154 and finished products made therefrom. The density of the manufactured aggregate pellets 154 may be, for example, about one-half that of conventional aggregates.

Thus, harmful or otherwise-valueless waste materials 136 are ameliorated into useful building materials, which may be mixed 168 with binder and water and formed 170 (FIG. 2) in any conventional manner, such as by pouring, casting, molding, extruding, or similar processes. Heavy metals, such as arsenic, selenium, cadmium, and the like, which would otherwise leach out of uncontained bottom ash or unsaleable fly ash from coal burning, for example, are encapsulated in building materials and stably isolated from the environment in non-soluble form. Additionally, because of their recycled content, concrete products made with manufactured aggregate material pellets 154 typically qualify for points towards certification under the Leadership in Energy and Environmental Design (LEED), a benchmark for the design, construction, and operation of high-performance “green” or environmentally-friendly buildings.

Thus, a process and method is provided for ameliorating harmful or otherwise-valueless waste materials into useful building materials, by first mixing waste materials with metal oxide (and optionally with water and/or calcium oxide) to form a first product or mixture, and subsequently adding and mixing an acid solution (such as phosphoric acid solution) to cause a chemical reaction resulting in a second product or mixture. The second product or mixture hardens and is passed through an agglomerator where it is reduced to smaller pieces, such as semi-spherical granules, which are then screened for size and used in place of conventional aggregates such as natural sand and gravel. The use of calcium oxide in the first product (already containing waste materials, metal oxide, and water), binds up phosphates in the waste materials to prevent their leaching out of the finished aggregate, such as may be useful in water filtration applications.

The resultant manufactured aggregate material may be blended with a binder, such as portland cement or mineral-based binders such as RenuAgg™, RenuStone™, or RenuBinder™ family of mineral-based binders, which is available, for example, from EnviroProducts International LLC of Longmont, Colo. Typically, the manufactured aggregate material may be blended or mixed with binder in the same ratios as natural aggregates or other manufactured aggregates to form a premix. Alternatively, the manufactured aggregate material may be used in place of gravel, sand, or in other applications where chemically stable filler or aggregate material is desired. In addition, the aggregate's porous properties allow it to be used in water or fluid filtration applications. Other commercial applications include, but are not limited to, growing media for environmentally-friendly roof tops or other surfaces (e.g., “bio roofs”), insulation boards, as an aggregate applied to roof top shingles, as a filler in cast products, water or other liquid filtration, artificial stones, and refractory products, etc., and such products may optionally be manufactured at lighter weights than would otherwise be possible with conventional or natural aggregates.

Changes and modifications in the specifically described embodiments may be carried out without departing from the principles of the present invention, which is intended to be limited only by the scope of the appended claims, as interpreted according to the principles of patent law including the doctrine of equivalents.

The embodiments of the invention in which an exclusive property or privilege is claimed are defined as follows:

1. A method of preparing aggregate material, said method comprising:
providing a waste material in granular form;
mixing the waste material with a metal oxide to obtain a first resultant product;
mixing the first resultant product with an acid to obtain a second resultant product; and
pelletizing the second resultant product to obtain the aggregate material.

2. The method according to claim 1, wherein said mixing the waste material with a metal oxide to obtain a first resultant product further comprises mixing the waste material and metal oxide with water.

3. The method according to claim 2, wherein said mixing the waste material with a metal oxide and water to obtain a first resultant product further comprises mixing the waste material, the metal oxide, and the water with calcium oxide.

4. The method according to claim 2, wherein the ratio of calcium oxide to waste material is between approximately 1:50 and 1:2000.

5. The method according to claim 4, wherein the ratio of calcium oxide to waste material is approximately 1:99.

6. The method according to claim 2, wherein said mixing the waste material with a metal oxide and water to obtain a first resultant product further comprises mixing the waste material, the metal oxide, and the water with a weak acid.

7. The method according to claim 2, further comprising:
providing a moisture sensor at the first mixer;
sensing the moisture content of the waste material; and
wherein said mixing the waste material and metal oxide with water comprises metering the water according to the moisture content of the waste material.

8. The method according to claim 1, wherein said mixing the waste material with a metal oxide to obtain a first resultant product further comprises mixing the waste material and the metal oxide with calcium oxide.

9. The method according to claim 1, wherein the metal oxide comprises a dry metal oxide.

10. The method according to claim 9, where the metal oxide comprises at least magnesium oxide.

11. The method according to claim 1, wherein the ratio of the waste material to the metal oxide in the first resultant product is between approximately 10:1 and 14:1.

12. The method according to claim 1, wherein the acid has a pH of between about zero and about four.

13. The method according to claim 12, wherein the acid comprises at least one chosen from phosphoric acid and oxalic acid.

14. The method according to claim 1, wherein the waste material comprises at least one chosen from bottom ash, unsaleable fly ash, paper, glass, rice hulls, crushed concrete, polymers, petrochemicals, sawdust, wood chips, MSW incinerator ash, MDF dust, kiln dust, or soil.

15. The method according to claim 1, further comprising:
providing a moisture sensor at the first mixer;
sensing the moisture content of the waste material; and
wherein said dispensing phosphoric acid into the first mixer comprises metering the phosphoric acid according to the moisture content of the waste material.

16. The method according to claim 1, wherein the acid comprises phosphoric acid, the metal oxide comprises magnesium oxide, and the waste material comprises bottom ash; and
wherein the ratio of bottom ash to phosphoric acid is between approximately 7:1 and 9:1.

17. The method according to claim 1, further comprising permitting the first resultant product to rest for at least about three hours prior to said mixing the first resultant product with an acid to obtain a second resultant product.

18. The method according to claim 1, further comprising mixing the pelletized aggregate material with a binder to form a concrete.

19. The method according to claim 18, further comprising forming a concrete product with the concrete.

20. A method of preparing aggregate material for use in concrete, said method comprising:
providing at least one waste hopper for containing a waste material therein, a first mixer, a second mixer, a magnesium oxide hopper, and an acid tank;
dispensing the waste material into the first mixer;
dispensing magnesium oxide from the magnesium oxide hopper into the first mixer;
mixing the waste material and the magnesium oxide in the first mixer to obtain a first resultant product;
dispensing the first resultant product into the second mixer;
dispensing phosphoric acid from the acid tank into the second mixer;
mixing the first resultant product and the phosphoric acid in the second mixer to obtain a second resultant product;
dispensing the second resultant product into an agglomerator; and
pelletizing the second resultant product in the agglomerator to obtain the aggregate material.

21. The method according to claim 20, wherein said dispensing the waste material into the first mixer comprises:
metering the waste material; and
conveying the waste material to the first mixer via a conveyor.

22. The method according to claim 20, further comprising:
providing a water tank spaced from the first mixer for containing water;
providing a moisture sensor at the first mixer;
sensing a moisture content of the waste material; and
metering water from the water tank into the first mixer to achieve a desired moisture content of the waste material.

23. The method according to claim 20, further comprising:
dispensing the pelletized aggregate material onto a screen; and
sorting the pelletized aggregate material at the screen.

24. The method according to claim 20, further comprising mixing the pelletized aggregate material with a binder to faun a concrete.

25. The method according to claim 24, further comprising forming a concrete product with the concrete.

26. The method according to claim 20, further comprising resting the first resultant product for at least about three hours prior to said dispensing phosphoric acid from the acid tank into the second mixer.

27. The method according to claim 20, wherein the waste material comprises at least one chosen from bottom ash, unsaleable fly ash, paper, glass, rice hulls, crushed concrete, polymers, petrochemicals, sawdust, wood chips, MSW incinerator ash, MDF dust, kiln dust, or soil.

28. A manufacturing facility for manufacturing aggregate material, said facility comprising:
a waste materials hopper for storing and dispensing a waste material;
a metal oxide hopper for storing and dispensing a metal oxide;
a water tank for storing and dispensing water;
a first mixer for receiving and mixing the waste material, the metal oxide, and the water, to produce a first resultant product, said first mixer adapted to dispense the first resultant product;
an acid tank for storing and dispensing an acid;
a second mixer for receiving and mixing the first mixture and the acid from the acid tank to produce a second resultant product upon reaction of the acid and the metal oxide;
an agglomerator adapted to pelletize the second resultant product into pellets; and
wherein the first resultant product at least partially results from a first chemical reaction in said first mixer, and the second resultant product at least partially results from a second chemical reaction in said second mixer.

29. The manufacturing facility according to claim 28, further comprising a calcium oxide hopper for storing and dispensing calcium oxide, wherein said first mixer is adapted to receive calcium oxide from said calcium oxide hopper and to mix the calcium oxide into the first resultant product.

30. The manufacturing facility according to claim 28, further comprising a weight sensor between said waste material hopper and said first mixer, said weight sensor adapted to measure the weight of the waste material conveyed thereon and to produce a weight signal indicative thereof.

31. The manufacturing facility according to claim 30, wherein said weight sensor comprises a weigh belt.

32. The manufacturing facility according to claim 30, further comprising:
a temperature sensor at said second mixer, said temperature sensor adapted to produce a temperature signal indicative of the temperature of the first resultant product;
a processor adapted to receive said temperature signal and said weight signal;
wherein said processor controls the amount of metal oxide added to said first mixer in response to said weight signal, and determines the progress of the second chemical reaction in response to said temperature signal.
